(19) United States
(12) Patent Application Publication
(10) Pub. No.: US 2015/0315753 A1
(43) Pub. Date: Nov. 5, 2015

(54) DRIVEWAY MARKER HOLDER

(71) Applicant: Scott Baltazar, Mt. Kisco, NY (US)

(72) Inventor: Scott Baltazar, Mt. Kisco, NY (US)

(21) Appl. No.: 14/269,623

(22) Filed: May 5, 2014

(51) Int. Cl. E01F 9/019; F16M 13/02

(52) U.S. Cl. CPC E01F 9/019; F16M 13/022

(57) ABSTRACT

The present invention is an adjustable holder for driveway markers. The holder is comprised of a clamping unit sized to fit over a typical curb. The clamping unit may take the form of a u-shaped bracket, l-shaped bracket, or c-shaped cuff. The clamping unit may include a thumbscrew that passes through it in order to adjust the clamping unit to the size of the particular curb to which it is applied. The driveway marker may be attached directly to the clamping unit, or may be inserted into a hollow piece which extends from the clamping unit.

### FIELD OF THE INVENTION

The present invention is a gripping device which attaches to a curb and serves as a holder for driveway markers.

### BACKGROUND OF THE INVENTION

Driveway markers are used to mark the edges of driveways, sidewalks and parking lots. The borders of such areas are often cobblestone, Belgium block, asphalt, or concrete curbs. The markers currently used are typically set back from the curb itself because the concrete that holds the curb flairs out underneath and makes it difficult to drive in the markers. Also, the markers tend to be displaced during changing weather. As a result, the markers are often not accurate representations of the curb location. Certain activities, such as the plowing of snow, without the accurate use of markers, may cause damage to curbs.

Currently there are no apparatuses to hold driveway markers in place. A simple adjustable holder is needed. In that regard, the present driveway marker holder has been developed to accomplish that objective with a minimal number of components.

### SUMMARY OF THE INVENTION

The disclosed invention is an adjustable holder for driveway markers which attaches to a curb. The holder is simple, reliable, relatively low cost, relatively easy to make and easy to use. It also includes a minimal number of components that may be comprised of many different suitable materials, such as molded plastic or metal.

### DESCRIPTION OF THE DRAWINGS

FIG. 1 is a side view of the disclosed invention.

FIG. 2 is a front view of the disclosed invention.

FIG. 3 is a rear view of the disclosed invention.

FIG. 4 is a cross-sectional view of the disclosed invention.

FIG. 5 is a front, top perspective view of the disclosed invention.

FIG. 6 is a side view of the disclosed invention mounted on a curb and holding a driveway marker.

FIG. 7 is a perspective view of the disclosed invention holding a driveway marker.

FIG. 8 is a side view of the disclosed invention wherein the driveway marker is attached directly to the clamping unit.

FIG. 9 is a side view of the disclosed invention wherein the clamping unit is an L-shaped bracket.

FIG. 10 is a side view of the disclosed invention wherein the clamping unit is a c-shaped cuff.

### DETAILED DESCRIPTION

The present invention is an adjustable holder for driveway markers 1. The holder is comprised of a clamping unit 3 sized to fit over a typical curb.

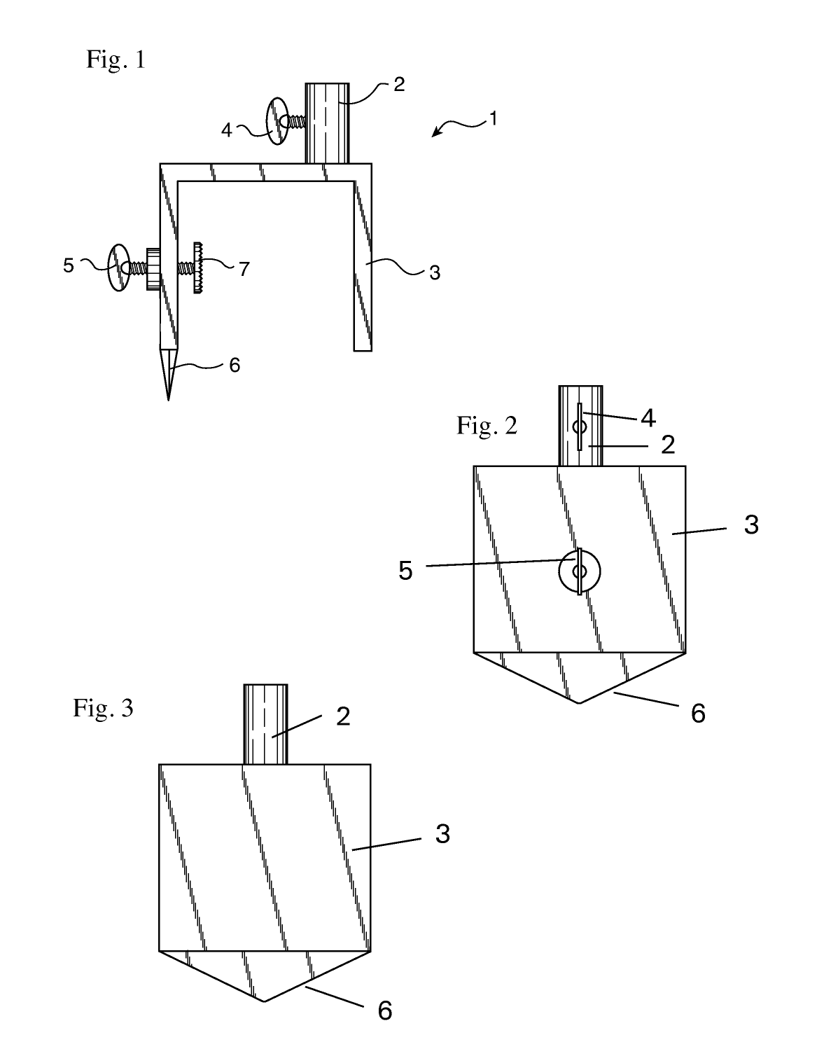

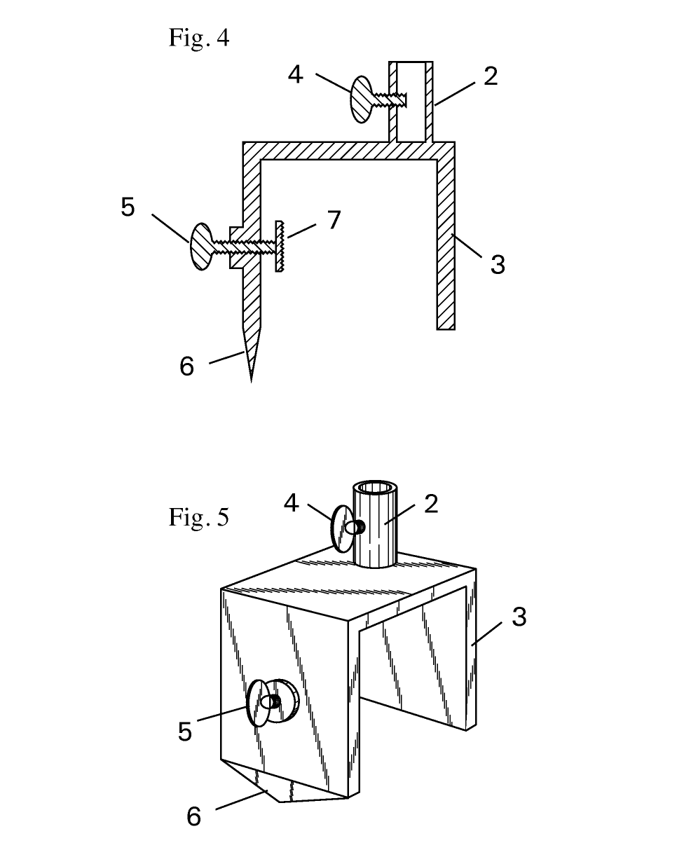

In one embodiment, as shown in FIG. 1-8, the clamping unit 3 is a u-shaped bracket. The u-shaped bracket may include a thumbscrew 5 with a crimped contact pad 7 that passes through one of the flanges of the u-shaped bracket. The thumbscrew 5 can be manually adjusted to provide a secure fit based upon the size of the curb.

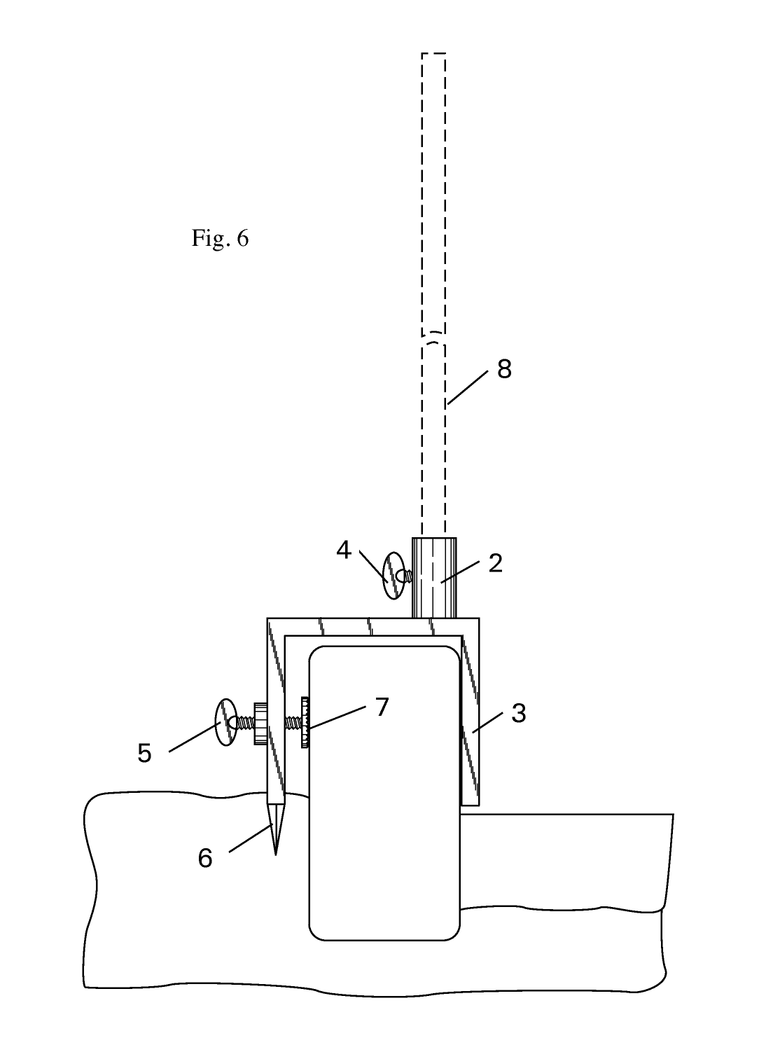

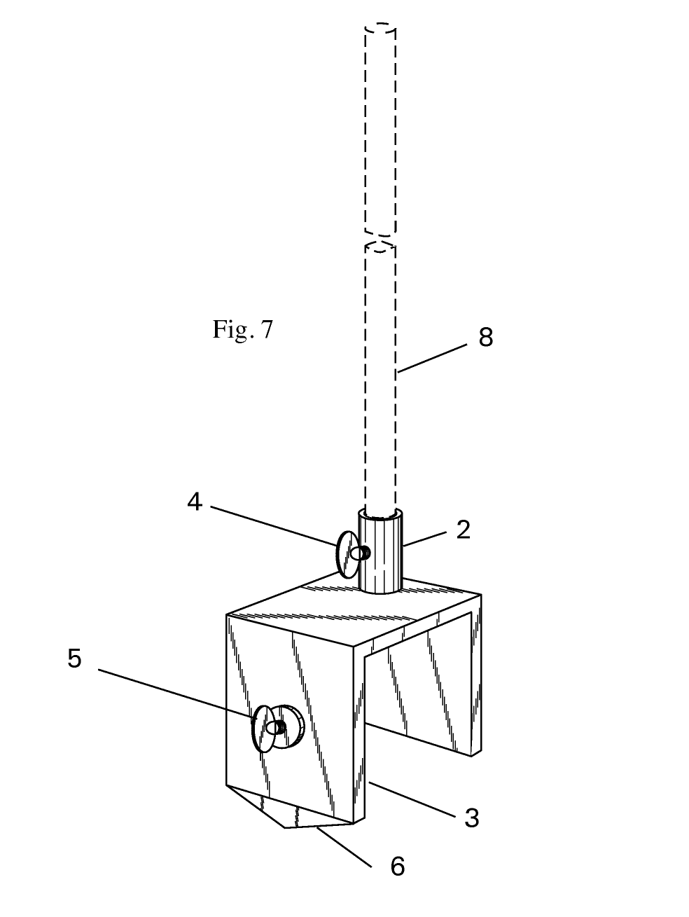

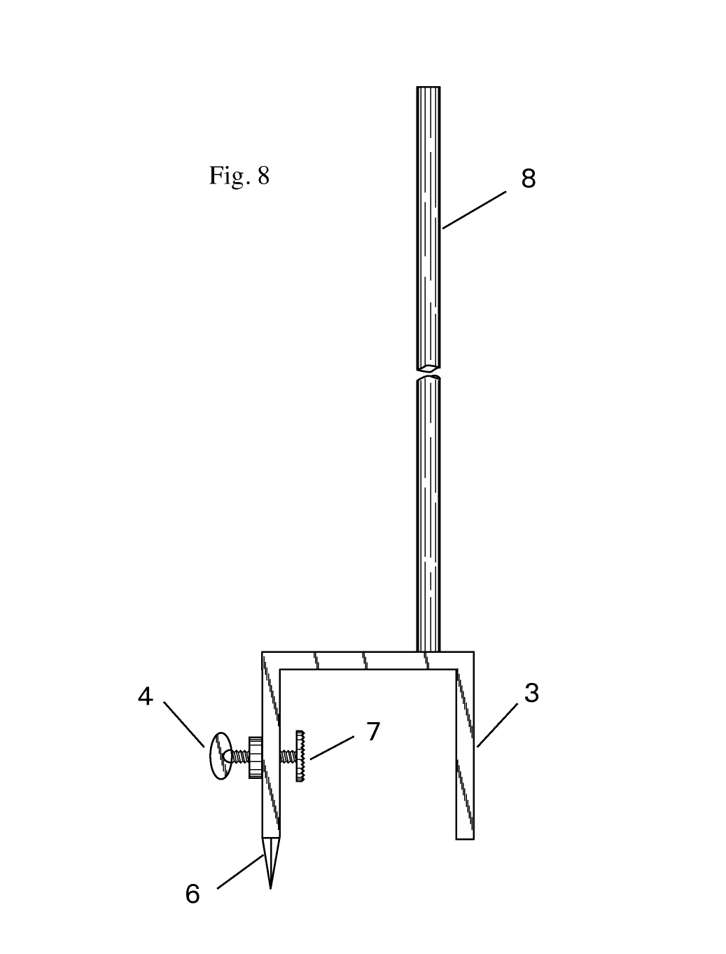

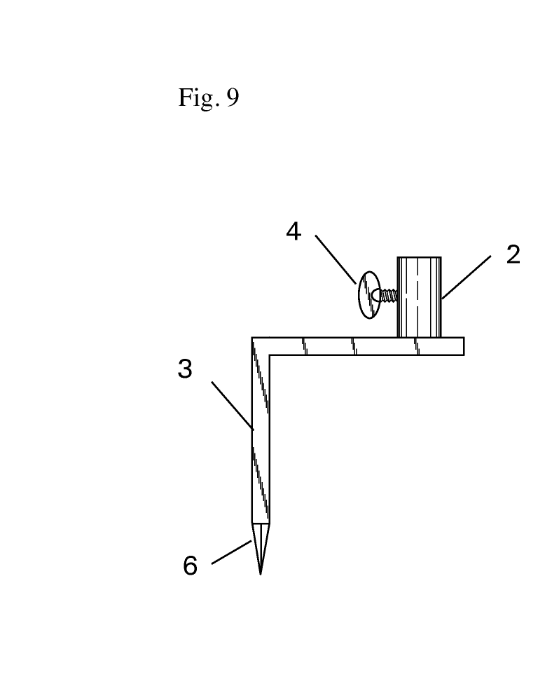

As shown in FIG. 8, a driveway marker 8 may be directly attached to the center panel of the u-shaped bracket. Alternatively, there may a hollow piece 2 which extends orthogonally from the center panel of the u-shaped bracket. The hollow piece 2 is cylindrically shaped and sized to allow a standard driveway marker (FIGS. 6, 7). There may also be an adjustable thumbscrew 4 that passes through the hollow piece 2 to provide a secure fit based upon the size of the marker inserted in the hollow piece 2. One or both of the flanges of the u-shaped bracket may end in a pointed shape 6, which is intended to be inserted into the ground. If only one flange ends in a pointed shape 6, the flange that ends in a pointed shape 6 extends further than the opposite flange.

In another embodiment, the clamping unit 3 is an L-shaped bracket. One of the flanges of the L-shaped bracket may end in a pointed shape 6. The flange which sits atop the curb may have a marker directly attached thereto, or may alternatively have a hollow piece 2 which extends orthogonally from the surface thereof. As in the aforementioned embodiments, the hollow piece 2 is a cylinder sized to allow a standard driveway marker. There may also be an adjustable thumbscrew 4 which passes through the hollow piece 2 to provide a secure fit based upon the size of the marker inserted in the hollow piece 2.

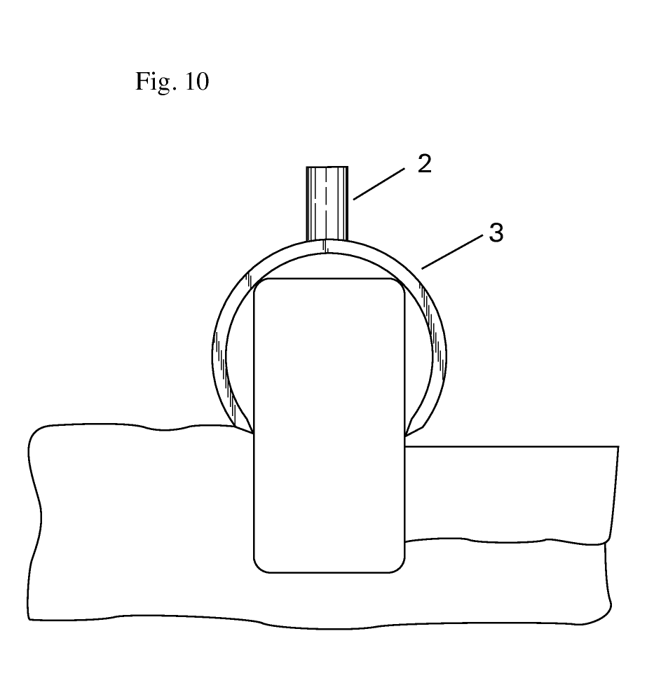

In yet another embodiment, as shown in FIG. 10, the clamping unit 3 is a c-shaped cuff, in tension, sized to fit around a standard curb. As in the other embodiments, the driveway marker 8 may be directly attached thereto or the cuff may have a hollow piece 2, as previously described herein, which projects radially therefrom, and sized allow a standard driveway marker. The hollow piece 2 may have an adjustable thumbscrew 4 that passes through it. The c-shaped cuff may have pointed edges to help secure its position.

The components of the adjustable holder for driveway markers can be molded plastic, but other construction materials, including metal, can be employed if desired.

The above is a detailed description of particular embodiments of the invention. It is recognized that departures from the disclosed embodiments may be made within the scope of the invention and that obvious modifications will occur to a person skilled in the art. Those of skill in the art should, in light of the present disclosure, appreciate that many changes can be made in the specific embodiments which are disclosed herein and still obtain a like or similar result without departing from the spirit and scope of the invention. All of the embodiments disclosed and claimed herein can be made and executed without undue experimentation in light of the present disclosure.

1. An adjustable holder for driveway markers comprised of:
a clamping unit;
a hollow piece which extends orthogonally from the clamping unit; and,
an adjustable thumbscrew;
wherein the adjustable thumbscrew passes through the hollow piece which extends orthogonally from the clamping unit.

2. The adjustable holder for driveway markers of claim 1 wherein the clamping unit is a u-shaped bracket comprised of a center panel and two flanges which extend orthogonally from the center panel.

3. The adjustable holder for driveway markers of claim 2 including an adjustable thumbscrew with a crimped contact pad on the end thereof, wherein the adjustable thumbscrew with the crimped contact pad on the end thereof passes through a flange of the u-shaped bracket.

4. The adjustable holder for driveway markers of claim 3 wherein the hollow piece extends orthogonally from the center panel of the u-shaped bracket.

5. The adjustable holder for driveway markers of claim 4 wherein the hollow piece is cylindrically shaped.

6. The adjustable holder for driveway markers of claim 3 wherein one of the flanges of the u-shaped bracket ends in a pointed shape and that flange extends further than the opposite flange.

7. The adjustable holder for driveway markers of claim 1 wherein the clamping unit is an L-shaped bracket comprised of two flanges that are perpendicular to each other.

8. The adjustable holder for driveway markers of claim 7 wherein the hollow piece extends orthogonally from one of the flanges.

9. The adjustable holder for driveway markers of claim 8 wherein the hollow piece is cylindrically shaped.

10. The adjustable holder for driveway markers of claim 8 wherein the flange from which the hollow piece does not extend ends in a pointed edge.

11. An adjustable holder for driveway markers of claim 1 wherein the clamping unit is a c-shaped cuff.

12. The adjustable holder for driveway markers of claim 11 wherein the edges of the c-shaped cuff are pointed.

13. An adjustable holder for driveway markers comprised of a clamping unit with a driveway marker attached thereto.

14. The adjustable holder for driveway markers of claim 13 wherein:
the clamping unit is a u-shaped bracket comprised of a center panel and two flanges which extend orthogonally from the center panel;
an adjustable thumbscrew with a crimped contact pad on the end thereof passes through one of the flanges of the u-shaped bracket; and,
the driveway maker is attached to the center panel of the u-shaped bracket.

15. The adjustable holder for driveway markers of claim 14 wherein one of the flanges of the u-shaped bracket ends in a pointed shape.

16. The adjustable holder for driveway markers of claim 13 wherein the clamping unit is an L-shaped bracket comprised of two flanges that are perpendicular to each other and the driveway marker is attached to one of the flanges thereof.

17. The adjustable holder for driveway markers of claim 16 wherein one of the flanges of the L-shaped bracket ends in a pointed shape.

18. The adjustable holder for driveway markers of claim 13 wherein the clamping unit is a c-shaped cuff with a driveway marker attached thereto.

19. The adjustable holder for driveway markers of claim 18 wherein the edges of the c-shaped cuff are pointed.

20. An adjustable holder for driveway markers comprised of:
a clamping unit; and,
a cylindrically shaped hollow piece which extends orthogonally from the clamping unit.

21. The adjustable holder for driveway markers of claim 20 wherein:
the clamping unit is a u-shaped bracket comprised of a center panel and two flanges which extend orthogonally from the center panel;
an adjustable thumbscrew with a crimped contact pad on the end thereof passes through one of the flanges of the u-shaped bracket; and,
the cylindrically shaped hollow piece is attached to the center panel of the u-shaped bracket.

22. The adjustable holder for driveway markers of claim 20 wherein the clamping unit is an L-shaped bracket comprised of two flanges that are perpendicular to each other and the cylindrically shaped hollow piece is attached to one of the flanges thereof.

23. The adjustable holder for driveway markers of claim 20 wherein the clamping unit is a c-shaped cuff.
